(19) United States
(12) Patent Application Publication
(10) Pub. No.: US 2020/0051447 A1
(43) Pub. Date: Feb. 13, 2020

(54) COGNITIVE TOOL FOR TEACHING GENERLIZATION OF OBJECTS TO A PERSON

(71) Applicant: International Business Machines Corporation, Armonk, NY (US)

(72) Inventors: Krishna R. Tunga, Wappingers Falls, NY (US); Lawrence A. Clevenger, Saratoga Springs, NY (US); Stefania Axo, Highland, NY (US); Mark C. Wallen, Highland, NY (US); Yang Liu, Yorktown Heights, NY (US); Shidong Li, Poughkeepsie, NY (US); Bryan Gury, Raleigh, NC (US)

(21) Appl. No.: 16/100,621

(22) Filed: Aug. 10, 2018

(51) Int. Cl. G09B 5/02; G06K 9/62; G06F 15/18; G06N 3/02

(52) U.S. Cl. CPC G09B 5/02; G06N 3/02; G06F 15/18; G06K 9/6276

(57) ABSTRACT

Provided are systems, methods, and media for teaching generalization of an object. An example method includes obtaining a set of traits of an object recognized by a person in an input image, in which a subset of traits are traits fixated on by the person when recognizing the object in the input image. Executing a machine learning algorithm to generate a set of generalized images of the object. Each generalized image is generated with at least one trait of being modified, in which the set of generalized images are ordered in a sequence based on proximity of each of the generalized images to the input image. Presenting at least a first generalized image to the person in accordance with the sequence. Modifying the order of the generalized images in the sequence in response to detecting from feedback that the person does not recognize the object in the first generalized image.

### BACKGROUND

The present invention generally relates to cognitive systems used for education, and more specifically, to cognitive systems for teaching generalization of objects to a person.

Children with autism often have difficulty with generalizing objects. Generalization generally refers to the process of transferring what is learned in one setting or situation to another setting or situation without explicit teaching or programming in the second transfer. One problem that may arise for people having a learning disability such as autism is that once the person is able to recognize a particular object, they tend to do so by overly fixating on a narrow set of properties of the object. This can result in the person misinterpreting similar objects that have different properties. For example, if a person with autism recognizes a toilet as being a toilet only when the seat of the toilet is black, the person may refuse to use the bathroom if they come across a toilet that has a white toilet seat instead of black.

Children with autism do not exhibit a binary behavior difference compared to children without autism. Children with autism exhibit difficulties on long a spectrum of disorders that extent to which may be different from one child to another. For example, children with autism may be different from each other with respect to objects that they have difficulty generalizing.

The phrase “machine learning” broadly describes a function of an electronic system that learns from data. A machine learning system, engine, or module can include a trainable machine learning algorithm that can be trained, such as in an external cloud environment, to learn functional relationships between inputs and outputs that are currently unknown.

### SUMMARY

Embodiments of the present invention provide a computer-implemented method for teaching generalization of an object to a person. A non-limiting example of the computer-implemented method includes obtaining, by a system comprising one or more processors, characteristic information pertaining to the object recognized by the person in an input image. The characteristic information includes a set of traits of the object pertaining to physical features of the object in the input image, in which a subset of traits of the set of traits comprises traits fixated on by the person when recognizing the object in the input image. The method includes executing, by the system, a machine learning algorithm to generate a set of generalized images of the object based on the subset of traits fixated on by the person. Each generalized image of the set of generalized images comprises an image of the object with at least one trait of the subset of traits being modified, in which the generalized images in the set of generalized images are ordered in a sequence based on proximity of each of the generalized images to the input image. The method includes presenting, by the system, to the person, at least a first generalized image of the set of generalized images in accordance with the sequence and receiving, by the system, feedback of the person regarding whether the person recognizes the object in the first generalized image. The method includes modifying, by the system, the order of the generalized images in the sequence in response to detecting from the feedback that the person does not recognize the object in the first generalized image.

Embodiments of the present invention provide a system for teaching generalization of an object to a person. The system includes one or more processors that are configured to perform a method. A non-limiting example of the method includes obtaining, by the system, characteristic information pertaining to the object recognized by the person in an input image. The characteristic information includes a set of traits of the object pertaining to physical features of the object in the input image, in which a subset of traits of the set of traits comprises traits fixated on by the person when recognizing the object in the input image. The method includes executing, by the system, a machine learning algorithm to generate a set of generalized images of the object based on the subset of traits fixated on by the person. Each generalized image of the set of generalized images comprises an image of the object with at least one trait of the subset of traits being modified, in which the generalized images in the set of generalized images are ordered in a sequence based on proximity of each of the generalized images to the input image. The method includes presenting, by the system, to the person, at least a first generalized image of the set of generalized images in accordance with the sequence and receiving, by the system, feedback of the person regarding whether the person recognizes the object in the first generalized image. The method includes modifying, by the system, the order of the generalized images in the sequence in response to detecting from the feedback that the person does not recognize the object in the first generalized image.

Embodiments of the invention provide a computer program product for teaching generalization of an object to a person, the computer program product comprising a computer readable storage medium having program instructions embodied therewith. The program instructions are executable by a system comprising one or more processors to cause the system to perform a method. A non-limiting example of the method includes obtaining, by the system, characteristic information pertaining the object recognized by the person in an input image. The characteristic information includes a set of traits of the object pertaining to physical features of the object in the input image, in which a subset of traits of the set of traits comprises traits fixated on by the person when recognizing the object in the input image. The method includes executing, by the system, a machine learning algorithm to generate a set of generalized images of the object based on the subset of traits fixated on by the person. Each generalized image of the set of generalized images comprises an image of the object with at least one trait of the subset of traits being modified, in which the generalized images in the set of generalized images are ordered in a sequence based on proximity of each of the generalized images to the input image. The method includes presenting, by the system, to the person, at least a first generalized image of the set of generalized images in accordance with the sequence and receiving, by the system, feedback of the person regarding whether the person recognizes the object in the first generalized image. The method includes modifying, by the system, the order of the generalized images in the sequence in response to detecting from the feedback that the person does not recognize the object in the first generalized image.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts an exemplary computer system capable of implementing one or more embodiments of the present invention;

FIG. 4 depicts an example distributed environment in accordance with one or more embodiments of the present invention;

FIG. 5 depicts an example user interface for inputting characteristic information pertaining to a physical object in accordance with one or more embodiments of the present invention;

FIG. 6 depicts an example user interface for presenting images to a user and for receiving feedback regarding the presented images in accordance with one or more embodiments of the present invention; and

FIG. 7 depicts a flow diagram illustrating a methodology in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. Also, the term “coupled” and variations thereof describes having a communications path between two elements and does not imply a direct connection between the elements with no intervening elements/connections between them. All of these variations are considered a part of the specification.

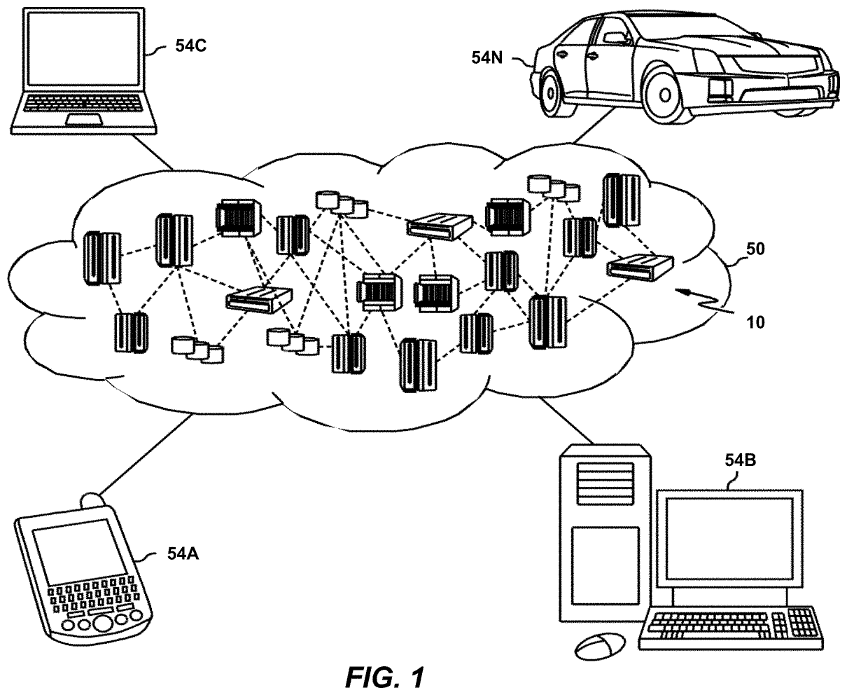

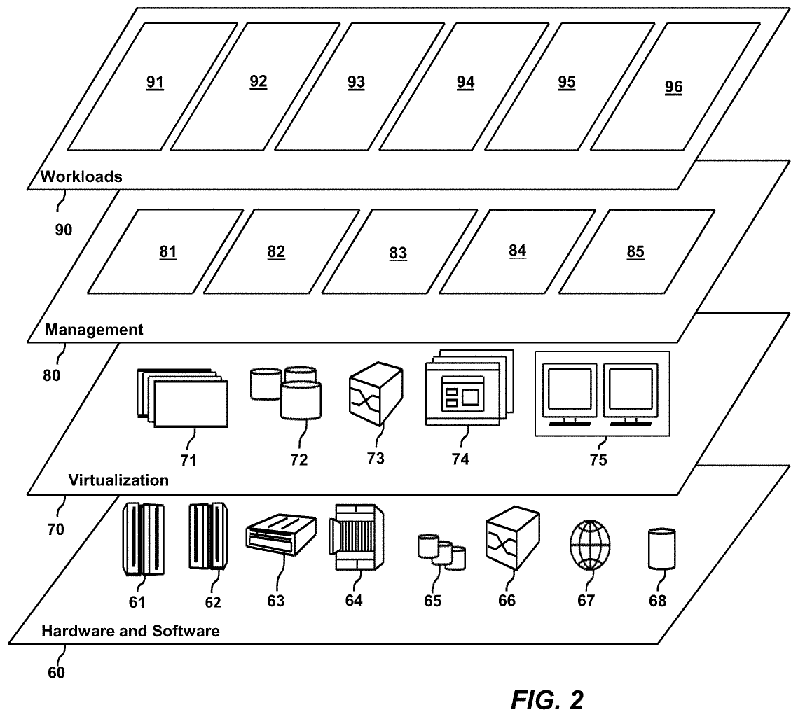

In the accompanying figures and following detailed description of the disclosed embodiments, the various elements illustrated in the figures are provided with two-digit or three-digit reference numbers. With minor exceptions (e.g., FIGS. 1-2), the leftmost digit of each reference number corresponds to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and object generalization processing 96.

Turning now to an overview of technologies that are more specifically relevant to aspects of the invention, as noted above, children with autism often have difficulty with generalizing objects. Generalization generally refers to the process of transferring what is learned in one setting or situation to another setting or situation without explicit teaching or programming in the second transfer. One problem that may arise for people having a learning disability such as autism is that once the person is able to recognize a particular object, they tend to do so by overly fixating on a narrow set of properties of the object. This can result in the person misinterpreting similar objects that have different properties. For example, if a person with autism recognizes a toilet as being a toilet only when the seat of the toilet is black, the person may refuse to use the bathroom if they come across a toilet that has a white toilet seat instead of black.

Some known systems assist children with autism to learn social skills such as recognizing facial expressions of a person. However, no cognitive and/or internet-of-things based solution exists that helps a child with autism generalize inanimate objects via an iterative person dependent machine learning process.

Turning now to an overview of the aspects of the invention, one or more embodiments of the invention address the above-described shortcomings of the prior art by providing a computing system that is configured to obtain a set of traits of an object recognized by a person in an input image, in which a subset of traits are traits fixated on by the person when recognizing the object in the input image. A machine learning algorithm is executed to generate a set of generalized images of the object. Each generalized image is generated with at least one trait of being modified, in which the set of generalized images are ordered in a sequence based on the proximity of each of the generalized images to the input image. At least a first generalized image is presented to the person in accordance with the sequence. In some embodiments of the present invention, feedback of the user is analyzed to track the effectiveness of the provided generalized images and the sequence of the presentation is then modified in view of the feedback.

The above-described aspects of the invention address the shortcomings of the prior art by providing a system that is capable of helping a child with autism learn to generalize different objects and become comfortable with different aspects, forms, and/or colors the same object by adjusting the autistic child's perception of on an object in a manner that is unique to abilities of the particular child.

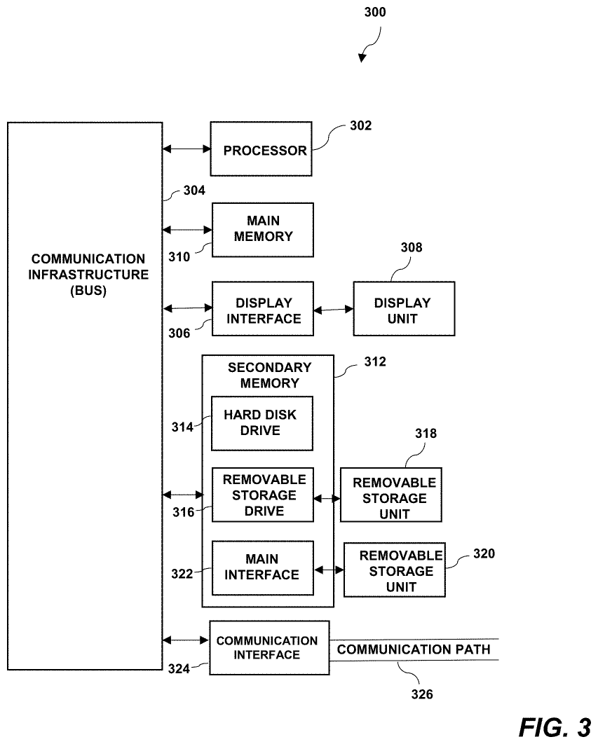

Turning now to a more detailed description of aspects of the present invention, FIG. 3 illustrates a high-level block diagram showing an example of a computer-based system 300 that is useful for implementing one or more embodiments of the invention. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional systems are in communication via communication path 326, (e.g., to communicate data between them).

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc., which is read by and written to by a removable storage drive 316. As will be appreciated, removable storage unit 318 includes a computer readable medium having stored therein computer software and/or data.

In some alternative embodiments of the invention, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etc. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using a wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310, and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

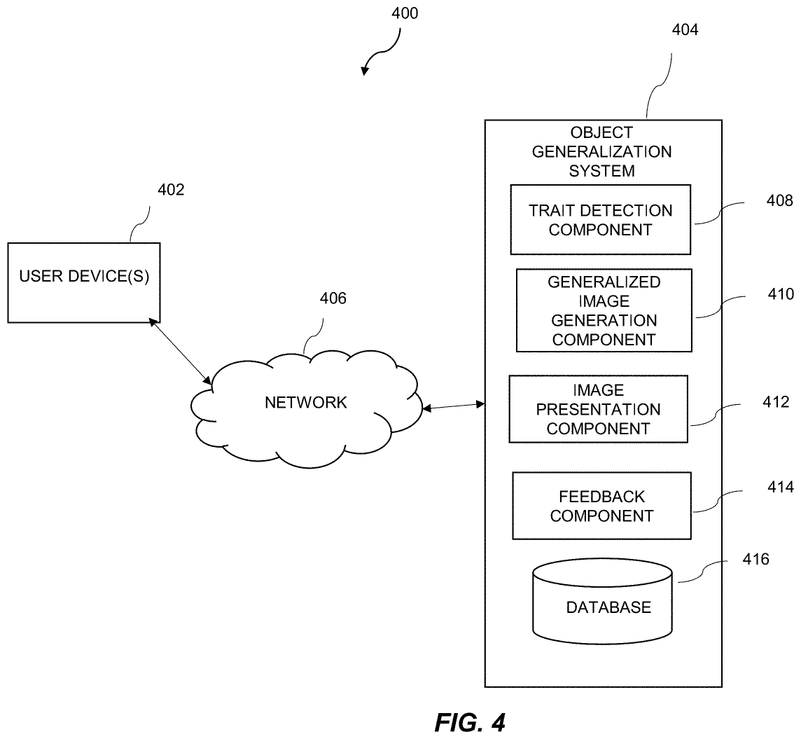

Referring now to FIG. 4, an example distributed environment 400 is presented for teaching generalization of an object to a person such as a child with autism. Distributed environment 400 includes one or more user devices 402 and an object generalization system 404, which are interconnected via network 406. FIG. 4 provides an illustration of only one example system and does not imply any limitation with regard to other systems in which different embodiments of the present invention may be implemented. Various suitable modifications to the depicted environment may be made, by those skilled in the art, without departing from the scope of the invention as recited by the claims.

Object generalization system 404 includes a trait detection component 408, generalized image generation component 410, image presentation component 412, feedback component 414, and database 416. In some embodiments of the present invention, trait detection component 408, generalized image generation component 410, image presentation component 412, feedback component 414, and/or database 416 are interconnected via a communication infrastructure 304 and/or communication path 326. Object generalization system 404 may have internal and external hardware components, such as those depicted and described above with respect to FIG. 3.

Object generalization system 404 is a machine learning system that can be utilized to solve a variety of technical issues (e.g., learning previously unknown functional relationships) in connection with technologies such as, but not limited to, machine learning technologies, video processing technologies, object generalization technologies, data analytics technologies, data classification technologies, data clustering technologies, recommendation system technologies, signal processing technologies, and/or other digital technologies. Object generalization system 404 employs hardware and/or software to solve problems that are highly technical in nature, that are not abstract and that cannot be performed as a set of mental acts by a human.

In certain embodiments of the invention, some or all of the processes performed by object generalization system 404 are performed by one or more specialized computers for carrying out defined tasks related to machine learning. In some embodiments of the invention, object generalization system 404 and/or components of the system are employed to solve new problems that arise through advancements in technologies mentioned above.

In general, object generalization system 404 is a cognitive-based tool that, in some embodiments of the present invention, applies one or more machine learning algorithms to extract traits of an object found in an image and to gradually teach a person to generalize the object by slowing changing the person's perception as to what is an acceptable representation of that object by modifying one or more traits on the object such as a color, height, material, texture of the object or other features of the object. For example, in some embodiments of the present invention, object generalization system 404 creates accepted generalized images of an object for a person with each image including a gradual change with respective to the object the person is fixated to. Object Generalization system 404 then displays the generalized image to the person to watch, interaction, and/or feel. As used herein an “image” refers generally to, but is not limited to, any suitable static image of an object, a video of an object, a physical 3D model of an object, a virtual 3D model of the object, and or combination thereof.

Machine learning is often employed by numerous technologies to determine inferences and/or relationships among digital data. For example, machine learning technologies, signal processing technologies, image processing technologies, data analysis technologies and/or other technologies employ machine learning models to analyze digital data, process digital data, determine inferences from digital data, and/or determine relationships among digital data. Machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

In some embodiments of the present invention, object generalization system 404 is a standalone computing device, a management server, a web server, a mobile computing device, or other suitable electronic device and/or computing system capable of receiving, sending, and processing data. In some embodiments of the present invention, object generalization system 404 is a server computing system utilizing multiple computers, such as in cloud computing environment 50. In some embodiments of the present invention, object generalization system 404 is a laptop computer, a tablet computer, a netbook computer, a personal computer (PC), a desktop computer, a personal digital assistant (PDA), a smart phone, or other suitable programmable electronic device capable of communicating with user device 402 and other computing devices (not shown) within distributed environment 400 via network 406. In some embodiments of the present invention, object generalization system 404 is a computing system utilizing clustered computers and components (e.g., database server computers, application server computers, etc.) that act as a single pool of seamless resources that are accessible within distributed environment 400. Object generalization system 404 may have internal and external hardware components, such as those depicted and described above with respect to FIG. 3.

Network 406 can be, for example, a telecommunications network, a local area network (LAN), a wide area network (WAN), such as the Internet, or a combination of the three, and can include wired, wireless, or fiber optic connections. Network 406 can include one or more wired and/or wireless networks that are capable of receiving and transmitting data, voice, and/or video signals, including multimedia signals that include voice, data, and video information. In general, network 406 can be any suitable combination of connections and protocols that can support communications between user device 402, object generalization system 404, and/or other computing devices (not shown) within a distributed environment 400. In some embodiments of the present invention, distributed environment 400 is implemented as part of a cloud computing environment such as cloud computing environment 50 (FIG. 1).

User device 402 is configured to allow users to send and/or receive information from user device 402 to object generalization system 404, which in turn allows users to access trait detection component 408, generalized image generation component 410, image presentation component 412, and/or feedback component 414. In some embodiments of the present invention, user device 402 is configured to gather user input data, biometric data, audible data, and/or visual data. For example, in some embodiment of the present invention, user device 402 includes one or more sensors for obtaining sensor data of the user, such as detecting head movement of the user and/or detecting a facial expression of the user. In some embodiments of the present invention, user device 402 is configured to capture audio, images, and/or video of the user (e.g., via a microphone and/or camera of user device 402).

In some embodiments of the present invention, user device 402 is a laptop computer, a tablet computer, a netbook computer, a personal computer (PC), a desktop computer, a personal digital assistant (PDA), a smart phone, an internet-of-things (IoT) enabled device, an IoT enable Virtual Reality (VR)/Augmented Realty (AR) space, and/or other suitable programmable electronic devices capable of communicating with various components and devices within distributed environment 400. In some embodiments of the present invention, user device 402 comprises two or more separate devices. For example, in some embodiments of the present invention, a first user device 402 is used to obtain characteristic data pertaining to an object whereas a second user device 402 is used to present images to a user and to provide feedback regarding a presented image. In some embodiments of the present invention, user device 402 is configured to present the image via the display screen. In some embodiments of the present invention, user device 402 is configured to present the image by 3D printing the object found in the image, which allows a user such as a child to touch and feel the object. In some embodiments of the present invention, user device 402 is a programmable electronic mobile device or a combination of programmable electronic mobile devices capable of executing machine readable program instructions and communicating with other computing devices (not shown) within distributed environment 400. In some embodiments of the present invention, user device 402 may include internal and external hardware components, such as those depicted and described above with respect to FIG. 3.

As noted above, object generalization system 404 is configured to gradually teach a person, such as a person having autism, to generalize a particular object by slowly changing the person's perception as to what is an acceptable representation of that object. This is achieved by modifying via machine learning one or more traits of an object that is presented to the person such as a color, height, and material, texture of the object or other features of the object over time. For example, if a person recognizes an object as being a chair when a chair is under four feet, but fails to recognize the object as being a chair when a chair is over four feet, object generalization system 404 assists the person in generalizing the chair by providing a sequence of images of a chair that slowly increase the height of the chair until the person is able to recognize the object as being a chair. The sequence is established via machine learning such that the sequencing is unique to the abilities of the person.

In the example depicted in FIG. 4, object generalization system 404 is configured to obtain characteristic information pertaining to a physical object recognized by a person in an input image (e.g., via trait detection component 408), in which the characteristic information includes a set of traits of the object pertaining to physical features of the object in the input image. Object generalization system 404 obtains a subset of traits of the set of traits that the person is fixated on when recognizing the object in the input image. For example, object generalization system 404 may obtain a set of traits of a chair that is recognized by a person as being a chair, in which the set of traits includes a height, a color, and a material. If the person only recognizes the chair as being a chair when the chair is presented with a particular height or color, then the subset of traits that the person is fixated on would include the color and height of the chair.

In some embodiments of the present invention, object generalization system 404 obtains the set of traits and the subset of traits that the person is fixated on via a user input that is obtained via user device 402. For example, in some embodiment of the present invention, the user is a caretaker or parent of the person. In some embodiments of the present invention, the user input includes a name of an object that is to be generalized, a certain set of traits of the object that is to be generalized, and/or a set of traits that the person is fixated on when recognizing the object.

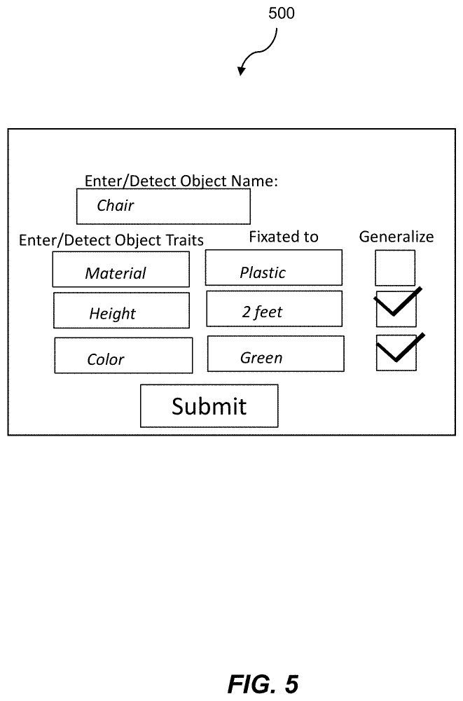

FIG. 5 illustrates an example user interface 500 for inputting characteristic information pertaining to a physical object in accordance with one or more embodiments of the present invention. In this example, a person is able to recognize a chair as being a chair but only under certain conditions, and thus a user (e.g., caretaker or parent of the person) seeks to assist the person in further generalizing the chair further. User interface 500 allows the user to input the name of the object, such as the name “chair” into a graphical user interface of the user device 402 to indicate the name of the object desired to be generalized. In some embodiments of the present invention, the user further enters one or more physical traits of the object, such as for example, a “material,” “height,” and/or “color”, which indicates the traits define the physical characteristics of an object such as a chair. The user enter attributes of the traits that the person is fixated on when the person is able to correctly recognize an object as being a chair such when, for example, the material of the chair is “plastic,” the height of the recognized chair is “2 feet,” and the color the chair is “green.”

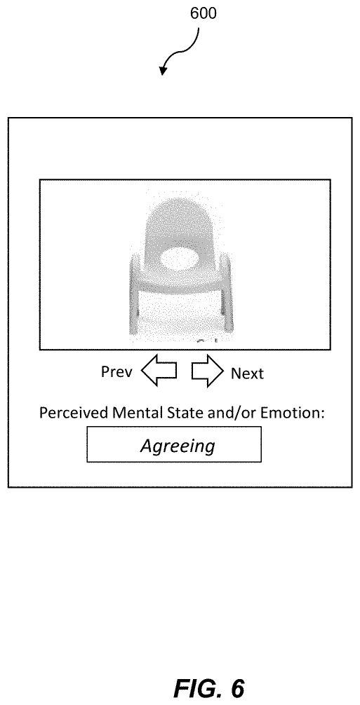

Referring back to FIG. 4, in some embodiments of the present invention, object generalization system 404 obtains the set of traits noted and the subset of traits that the person is fixated on without or in addition to relying on data being entered by a user (e.g., data entered via user interface 500). For example, in some embodiments of the present invention, object generalization system 404 obtains the set of traits and the subset of traits by first presenting a set of predetermined images to the person (e.g., via image presentation component 412), in which each predetermined image is of a different predetermined object of a plurality of different predetermined objects (e.g., a chair, a toilet, a car, etc.). As noted above, each image may be presented as one or more of a static image of an object, a video of an object, a physical 3D model of an object, a virtual 3D model of the object via user device 402. After presenting one or more predetermined images to the person from the set of predetermined images, object generalization system 404 detects for each of the predetermined objects that are presented to the person whether the person recognizes the object that is being presented. In some embodiments of the present invention, object generalization system 404 detects whether a predetermined object is recognized by the person via utilization of feedback component 414 and obtaining feedback from the person via user device 402. For example, in some embodiments of the present invention, the feedback is obtained indirectly from the person by monitoring a mental and/or emotional state of the person which is perceived by a sensing component of user device 402. In some embodiments of the present invention, the feedback is obtained directly from the person, by for example, the person clicking on icons indicating whether or not the person recognized a particular presented image. FIG. 6 illustrates an example user interface 600 for presenting images to a user and for receiving feedback regarding the presented images to indicate whether the person recognizes the particular displayed object.

In response to detecting that a predetermined object was not recognized by the person, object generalization system 404 then continues presenting predetermined images until object generalization system 404 identifies a second predetermined object that is recognized by the person (e.g., via feedback component 414), in which the second predetermined object recognized by the person is in the same generalization category as the predetermined object that was not recognized by the person. For example, if object generalization system 404 detects that the person does not recognize a predetermined image of a chair, object generalization system 404 presents other predetermined images of other chairs (e.g., via image presentation opponent 412), such as chairs with different colors as compared to the originally present chair, and/or different sizes, materials, textures, or other features. The predetermined images may be obtained from, for example, database 416 via a search engine the queries the database 416 to identify images of one or more relevant predetermined objects. Object generalization system 404 then presents a plurality of images of the second predetermined object to the person, in which each image of the plurality of images of the second predetermined object includes a modification to a different respective trait of the second predetermined object. For example, if the person recognizes a chair that happens to be colored blue, object generalization system 404 presents images of other chairs that are each different from one another based on one or more properties such as color, size, material, and/or texture. Object generalization system 404 then executes a machine learning algorithm to extract one or more traits of the second predetermined object the person is fixated on when the person is able to recognize the second predetermined object in one or more of the presented images of the second object. The object that is used by object generalization system 404 is the second predetermined object, in which the subset of traits fixated on by the person includes the extracted one or more traits of the second predetermined object.

The following is an example flow of an algorithm for detecting traits of an object that are fixated on by a child with autism when the child is able to recognize the object as being the object. First, object generalization system 404 collects data about the autistic child's reactions to different objects (e.g., agreement, disagreement, etc.). The reaction data may be obtained by feedback component 414, which in some embodiments is configured to receive feedback data from one or more input interfaces or sensors of user device 402 to detect an emotional response of the person. Example input interfaces and sensors include, but is not limited to, smart cameras, heart rate monitors, microphones, keyboard inputs, mouse inputs, and/or other interfaces or sensors that are able to capture feedback from the person. For example, in some embodiments of the present invention user device 402 includes a VR glass apparatus and/or interface that is integrated with sensors for detecting galvanic skin response (GSR), brain wave (EEG), and/or pupil size dilation. For each object that the child is detected as being averse to (e.g., object that the child does not recognize), in some embodiments of the present invention, object generalization system 404 then looks for objects that the child is not averse to that fall into the same category and/or generalization as the object of the aversion. For example, if object generalization system 404 detects that the child is averse to toilets that have a toilet seat that is white, object generalization system 404 then looks for images of toilets that the child is not averse to. For each object that the child accepts (e.g., recognizes the objection in the image), object generalities system 404 then identifies what particular traits the person is averse to. For example, in some embodiments of the present invention, the identification of objects of aversion is obtained by trial and error by application of a machine learning algorithm that slowing changing a color, shape, and/or size of the black toilet seat to understand the particular aversion. Based on the trial and error process, object generalization system 404 may identify that the color the seat is the feature that causes the person to be averse to a presented toilet, such as when a toilet seat is black. After having found that the child is averse to toilets that have black toilet seats, object generalization system 404 then morphs each of the accepted objects into objects of aversion to teach generalization of the object (e.g., via modifying a trait of the object until the child recognizes the object of the aversion). For example, given that a black toilet seat is accepted and that a white toilet seat is not accepted, in some embodiments of the present invention, object generalization system 404 creates one or more generalized images of the toilet seat, which are modified versions of the original toilet seat but with different colors.

Referring back to FIG. 4, after obtaining characteristic information pertaining to a physical object recognized by a person in an input image, object generalization system 404 is configured execute a machine learning algorithm to generate a set of generalized images of the object based on the subset of traits fixated on by the person. In some embodiments of the present invention, the subset of traits fixated on by the person includes at least one of a color of a feature of the object in the input image, a height of a feature of the object in the input image, a material of a feature of the object in the input image, or a texture of a feature of the object in the input image.

Each image of the set of generalized images is generated such that it displays the object with at least one trait of the subset of traits being modified over time. The generalized images in the set of generalized images are ordered in a sequence based on the proximity of each of the generalized images to the input image. In some embodiments of the present invention, each generalized image or the set of generalized images is one or more of a static image of the object, a video of the object, a physical 3D model of the object, or a virtual 3D model of the object.

In some embodiments of the present invention, object generalization system 404 generated the set of generalized images and sequences the set of generalized images by processing a machine learning model that is based on features that are extracted from the one or more input images and/or feedback obtained from the person. In some embodiments of the present invention, object generalization system 404 employs parallel computing to process portions of the images and/or feedback to search database 416 to identify relevant images. For instance, in some embodiments of the invention, object generalization system 404 2 performs parallel computing associated with two or more processors that process one or more portions of images and/or feedback in parallel. In one example, object generalization system 404 executes a classification machine learning model using the features extracted from the input images and/or feedback to identify which traits of the object to modify, by how much, and in which order. In some embodiments of the present invention, the images are received as input from database 416 or from user device 402. In some embodiments of the present invention, the classification machine learning model maps extracted features to one or more categories. In another example, object generalization system 404 executes a regression machine learning model using extracted features. In some embodiments of the present invention, a regression machine learning model is used to determine relationships among traits of objects in an input image and traits of objects in generalized images. In yet another example, object generalization system 404 executes a clustering machine learning model using a feature matrix that is populated based at least in part on the features that are extracted from the received images and/or feedback.

In some embodiments of the invention, the clustering machine learning model is a machine learning model that groups related data from the input images and/or feedback into a corresponding group using a grouping technique such as, for example, a k nearest neighbor's (KNN) technique. For example, in some embodiments of the present invention, the proximity of each of the generalized images to the input image is determined based object generalization system 404 applying a k-nearest neighbors (KNN) algorithm. In some embodiments of the present invention, the proximity of each of the generalized images to the input image is determined by object generalization system 404 based on applying a decision tree algorithm. In particular, in some embodiments of the present invention, at least one of a KNN or a decision tree algorithm is applied to determine how similar an intermediate generalized object is in comparison to the object that the child was originally fixated to.

After the set of generalized images is generated and sequenced, object generalization system 404 is configured to present at least a first generalized image of the set of generalized images to the person in accordance with the sequence (e.g., via image presentation component 412) to assist the person in learning to generalize the object. In some embodiments of the present invention, object generalization system 404 is configured to receive feedback of the person regarding whether the person recognizes the object in the first generalized image (e.g., via feedback component 414) to ascertain whether the presentation is effective. In response to detecting from the feedback that the person does not recognize the object in the first generalized image, object generalization system 404 is configured to modify the order of the generalized images in the sequence to adapt to the abilities of the person.

For example, in the context of a scenario where a person accepts toilets when they have black toilet sets but is averse to toilets that have white toilet seats, a sequence of generalized images of toilets is first created in which each toilet includes one or more portions having the color black. Each generalized image has a different number of black colored portions such as, for example, one toilet seat of a generalized image being 100% entirely black (image A), one toilet seat of a generalized image being 75% black and 25% white (image B), one toilet seat of a generalized image being 50% black and white (image C), one toilet seat of a generalized image being 25% black and 75% white (image D), one toilet seat of a generalized image being 100% white (image E). The images are sequenced using machine learning based on the proximity of each of the generalized images to the original input image. For example, a first sequence may be to present the generalized images in the following order: image A, image B, image C, image D, and then image E. After each generalized image is presented, feedback is obtained from the person regarding whether the person recognizes a given generalized image. In some embodiments of the present invention, if the person recognized the generalized image then a next generalized image in the sequence is presented. For example, if the person recognizes image A as being a toilet, then image B is presented. If the person does not recognize the generalized image, then the sequence of generalized images is modified such that the images are presented in an order that adapts to the person's ability to recognize the object. For example, if the person fails to recognize image C (generalized image being 50% black and white), then in some embodiments of the present invention the sequence is modified such a next image is shown that includes more black than white, such as by presenting image A, image B, or a different image such as an image of a toilet having a toilet seat that is 60% black and 40% white is presented next. In some embodiments of the present invention, instead of a plurality of generalized images being generated, a single generalized image is created and then morphed after the presentation to further change the modified trait of the object.

In some embodiments of the present invention, subsequent to modifying the order of the generalized images, object generalization system 404 is configured to present a second generalize image of the set of generalized images to the person in accordance with the modified sequence. In some embodiments of the present invention, the process of providing a generalized image, obtaining feedback, and then selectively modifying the sequence is performed for all the images in the sequence until all the generalized images in the set are presented.

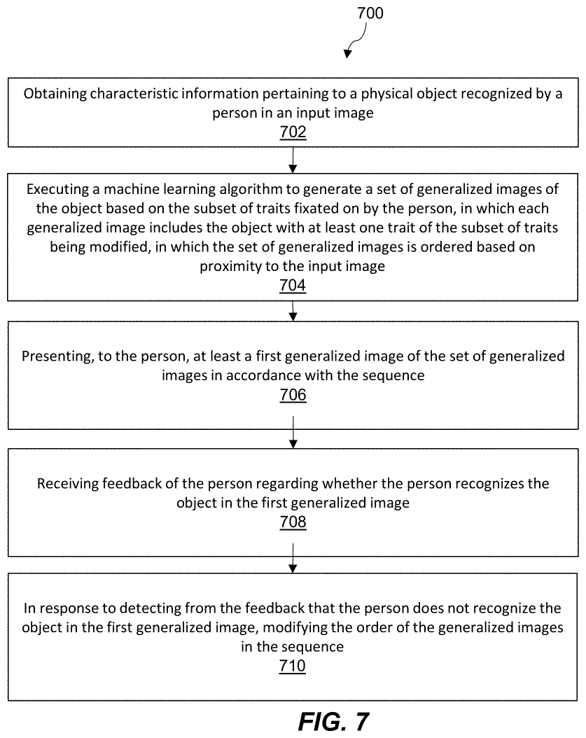

Additional details of the operation of system 404 will now be described with reference to FIG. 7, wherein FIG. 7 depicts a flow diagram illustrating a methodology 700 according to one or more embodiments of the present invention. At 702, characteristic information pertaining to a physical object recognized by a person in an input image is obtained by object generalization system 404 (e.g., via trait detection component 408). The characteristic information includes a set of traits of the object pertaining to physical features of the object in the input image, in which a subset of traits of the set of traits comprises traits fixated on by the person when recognizing the object in the input image. At 704, a machine learning algorithm is executed by object generalization system 404 (e.g., via generalized image generation component 410) to generate a set of generalized images of the object based on the subset of traits fixated on by the person. Each generalized image of the set of generalized images comprises an image of the object with at least one trait of the subset of traits being modified, in which the generalized images in the set of generalized images are ordered in a sequence based on the proximity of each of the generalized images to the input image. At 706 one or more generalized images of the set of generalized images is presented by object generalization system 404 (e.g., via image presentation component 412) to the person in accordance with the sequence. In some embodiments of the present invention, the images are presented one at a time. At 708, feedback of the person regarding whether the person recognizes the object in the first generalized image is received by object generalization system 404 (e.g., via feedback component 414). At 710 the order of the generalized images in the sequence is modified by object generalization system 404 (e.g., via generalized image generation component 410) in response to detecting from the feedback that the person does not recognize the object in the first generalized image.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for teaching generalization of an object to a person, the method comprising:
obtaining, by a system comprising one or more processors, characteristic information pertaining to the object recognized by the person in an input image, wherein the characteristic information includes a set of traits of the object pertaining to physical features of the object in the input image, wherein a subset of traits of the set of traits comprises traits fixated on by the person when recognizing the object in the input image;
executing, by the system, a machine learning algorithm to generate a set of generalized images of the object based on the subset of traits fixated on by the person, wherein each generalized image of the set of generalized images comprises an image of the object with at least one trait of the subset of traits being modified, wherein the generalized images in the set of generalized images are ordered in a sequence based on proximity of each of the generalized images to the input image;
presenting, by the system, to the person, at least a first generalized image of the set of generalized images in accordance with the sequence;
receiving, by the system, feedback of the person regarding whether the person recognizes the object in the first generalized image; and
in response to detecting from the feedback that the person does not recognize the object in the first generalized image, modifying, by the system, the order of the generalized images in the sequence.

2. The computer-implemented method of claim 1 further comprising:
subsequent to modifying the order of the generalized images, presenting, by the system, a second generalized image of the set of generalized images to the person in accordance with the modified sequence.

3. The computer-implemented method of claim 1, wherein obtaining the characteristic information includes:
presenting a set of predetermined images to the person, wherein each predetermined image is of a different predetermined object of a plurality of different predetermined objects;
detecting for each of the predetermined objects whether the person recognizes the presented predetermined object;
in response to detecting that a predetermined object was not recognized by the person, identifying a second predetermined object that is recognized by the person, wherein the second predetermined object recognized by the person is in a same generalization category as the predetermined object that was not recognized by the person;
presenting a plurality of images of the second predetermined object to the person, wherein each image of the plurality of images of the second predetermined object includes a modification to a different respective trait of the second predetermined object; and
executing, by the system, a machine learning algorithm to extract one or more traits of the second predetermined object the person is fixated on when recognizing the second predetermined object, wherein the object of the input image is the second predetermined object, and wherein the subset of traits fixated on by the person comprises the extracted one or more traits of the second predetermined object.

4. The computer-implemented method of claim 1, wherein the subset of traits fixated on by the person includes at least one of a color of a feature of the object in the input image, a height of a feature of the object in the input image, a material of a feature of the object in the input image, or a texture of a feature of the object in the input image.

5. The computer-implemented method of claim 1, wherein at least one generalized image of the set of generalized images comprises a static image of the object, a video of the object, a physical 3D model of the object, or a virtual 3D model of the object.

6. The computer-implemented method of claim 1, wherein the proximity of each of the generalized images to the input image is determined based on applying a decision tree algorithm.

7. The computer-implemented method of claim 1, wherein the proximity of each of the generalized images to the input image is determined based on applying a k-nearest neighbors (KNN) algorithm.

8. A computer program product for teaching generalization of an object to a person, the computer program product comprising a computer readable storage medium having program instructions embodied therewith, the program instructions executable by a system comprising one or more processors to cause the system to perform a method, the method comprising:
obtaining, by the system, characteristic information pertaining to the object recognized by the person in an input image, wherein the characteristic information includes a set of traits of the object pertaining to physical features of the object in the input image, wherein a subset of traits of the set of traits comprises traits fixated on by the person when recognizing the object in the input image;
executing, by the system, a machine learning algorithm to generate a set of generalized images of the object based on the subset of traits fixated on by the person, wherein each generalized image of the set of generalized images comprises an image of the object with at least one trait of the subset of traits being modified, wherein the generalized images in the set of generalized images are ordered in a sequence based on proximity of each of the generalized images to the input image;
presenting, by the system, to the person, at least a first generalized image of the set of generalized images in accordance with the sequence;
receiving, by the system, feedback obtained from the person regarding whether the person recognizes the object in the first generalized image; and
in response to detecting from the feedback that the person does not recognize the object in the first generalized image, modifying, by the system, the order of the generalized images in the sequence.

9. The computer program product of claim 8, wherein the method further comprises:
subsequent to modifying the order of the generalized images, presenting, by the system, a second generalized image of the set of generalized images to the person in accordance with the modified sequence.

10. The computer program product of claim 8, wherein obtaining the characteristic information includes:
presenting a set of predetermined images to the person, wherein each predetermined image is of a different predetermined object of a plurality of different predetermined objects;
detecting for each of the predetermined objects whether the person recognizes the presented predetermined object;
in response to detecting that a predetermined object was not recognized by the person, identifying a second predetermined object that is recognized by the person, wherein the second predetermined object recognized by the person is in a same generalization category as the predetermined object that was not recognized by the person;
presenting a plurality of images of the second predetermined object to the person, wherein each image of the plurality of images of the second predetermined object includes a modification to a different respective trait of the second predetermined object; and
executing, by the system, a machine learning algorithm to extract one or more traits of the second predetermined object the person is fixated on when recognizing the second predetermined object, wherein the object of the input image is the second predetermined object, and wherein the subset of traits fixated on by the person comprises the extracted one or more traits of the second predetermined object.

11. The computer program product of claim 8, wherein the subset of traits fixated on to by the person includes at least one of a color of a feature of the object in the input image, a height of a feature of the object in the input image, a material of a feature of the object in the input image, or a texture of a feature of the object in the input image.

12. The computer program product of claim 8, wherein at least one generalized image of the set of generalized images comprises a static image of the object, a video of the object, a physical 3D model of the object, or a virtual 3D model of the object.

13. The computer program product of claim 8, wherein the proximity of each of the generalized images to the input image is determined based on applying a decision tree algorithm.

14. The computer program product of claim 8, wherein the proximity of each of the generalized images to the input image is determined based on applying a k-nearest neighbors (KNN) algorithm.

15. A system for teaching generalization of an object to a person, the system comprising one or more processors configured to perform a method, the method comprising:
obtaining, by the system, characteristic information pertaining to the object recognized by the person in an input image, wherein the characteristic information includes a set of traits of the object pertaining to physical features of the object in the input image, wherein a subset of traits of the set of traits comprises traits fixated on by the person when recognizing the object in the input image;
executing, by the system, a machine learning algorithm to generate a set of generalized images of the object based on the subset of traits fixated on by the person, wherein each generalized image of the set of generalized images comprises an image of the object with at least one trait of the subset of traits being modified, wherein the generalized images in the set of generalized images are ordered in a sequence based on proximity of each of the generalized images to the input image;
presenting, by the system, to the person, at least a first generalized image of the set of generalized images in accordance with the sequence;
receiving, by the system, feedback of the person regarding whether the person recognizes the object in the first generalized image; and
in response to detecting from the feedback that the person does not recognize the object in the first generalized image, modifying, by the system, the order of the generalized images in the sequence.

16. The system of claim 15, wherein the method further comprises:
subsequent to modifying the order of the generalized images, presenting, by the system, a second generalized image of the set of generalized images to the person in accordance with the modified sequence.

17. The system of claim 15, wherein obtaining the characteristic information includes:
presenting a set of predetermined images to the person, wherein each predetermined image is of a different predetermined object of a plurality of different predetermined objects;
detecting for each of the predetermined objects presented whether the person recognizes the presented predetermined object;
in response to detecting that a predetermined object was not recognized by the person, identifying a second predetermined object that is recognized by the person, wherein the second predetermined object recognized by the person is in a same generalization category as the predetermined object that was not recognized by the person;
presenting a plurality of images of the second predetermined object to the person, wherein each image of the plurality of images of the second predetermined object includes a modification to a different respective trait of the second predetermined object; and
executing, by the system, a machine learning algorithm to extract one or more traits of the second predetermined object the person is fixated on when recognizing the second predetermined object, wherein the object of the input image is the second predetermined object, and wherein the subset of traits fixated on by the person comprises the extracted one or more traits of the second predetermined object.

18. The system of claim 15, wherein the subset of traits fixated on by the person includes at least one of a color of a feature of the object in the input image, a height of a feature of the object in the input image, a material of a feature of the object in the input image, or a texture of a feature of the object in the input image.

19. The system of claim 15, wherein at least one generalized image of the set of generalized images comprises a static image of the object, a video of the object, a physical 3D model of the object, or a virtual 3D model of the object.

20. The system of claim 15, wherein the proximity of each of the generalized images to the input image is determined based on applying at least one of a decision tree algorithm or a k-nearest neighbors (KNN) algorithm.
